(19) United States
(12) Patent Application Publication
(10) Pub. No.: US 2013/0309503 A1
(43) Pub. Date: Nov. 21, 2013

(54) METHOD FOR MANUFACTURING A FLAME-RESISTANT AND TRANSPARENT FILM, AND FLAME-RESISTANT AND TRANSPARENT FILM MANUFACTURED USING SAME

(71) Applicants: Chang Hak Shin, Seoul (KR); Eung Kee Lee, Anyang-si (KR); Sang Won You, Daejeon (KR); Min Hee Lee, Gunpo-si (KR); Tae Hwa Lee, Gwangmyeong-si (KR)

(72) Inventors: Chang Hak Shin, Seoul (KR); Eung Kee Lee, Anyang-si (KR); Sang Won You, Daejeon (KR); Min Hee Lee, Gunpo-si (KR); Tae Hwa Lee, Gwangmyeong-si (KR)

(73) Assignee: LG HAUSYS, LTD., Seoul (KR)

(21) Appl. No.: 13/982,600

(22) PCT Filed: Jun. 5, 2012
(86) PCT No.: PCT/KR2012/004424

§ 371 Date: Jul. 30, 2013

(30) Foreign Application Priority Data
Jun. 7, 2011 (KR) 10-2011-0054343

(51) Int. Cl. C09D 5/18; C08G 77/26; C08L 83/04

(52) U.S. Cl. CPC C09D 5/18; C08L 83/04; C08G 77/26
USPC 428/413; 428/446; 428/451; 427/335

(57) ABSTRACT

Disclosed is a method for manufacturing a flame resistant and transparent film having a high transparency after imparting flame resistance through flame resistance treatment. The method for manufacturing the flame resistant and transparent film according to the present invention comprises the steps of: (a) preparing a transparent base film; (b) forming a flame resistant coating layer by coating a flame resistant material comprising a polysilazane onto at least one surface of the base film; (c) drying the flame-resistant coating layer so as to remove residual solvents in the flame-resistant coating layer; and (d) curing the flame-resistant coating layer under a humid environment. The present invention is characterized by the flame-resistant coating layer and a laminated body of the base film having an optical property in which a measured haze value is less than 0.3.

### TECHNICAL FIELD

The present invention relates to a method for manufacturing a flame retardant transparent film, and a flame retardant transparent film manufactured by the same and, more particularly, to a method for manufacturing a flame retardant transparent film exhibiting outstanding flame retardancy and transparency.

### BACKGROUND ART

Flame retardants refer to materials exhibiting properties of delaying combustion when exposed to heat or flame. Such flame retardants are widely used to delay ignition and prevent combustion from spreading through improvement in physical and chemical properties of combustible polymeric materials.

With increasing use of polymeric materials in the field of building construction, vehicles, electronics, aircraft industries, and the like, there is an increasing demand for polymeric materials having flame retardancy for safety against fire, and demand for flame retardants is also increasing.

Existing methods of imparting flame retardancy may be divided into two types, that is, a method of adding additives to a base material and physically mixing the same, and a method of coating a solution on a surface of a base material.

First, the method of imparting flame retardancy to a polymeric material using additives is relatively inexpensive and allows easy compounding of the polymeric material with the additives. Currently, organic flame retardants such as phosphorous, bromine and chlorine-based flame retardants, inorganic flame retardants such as aluminum, antimony, and magnesium-based flame retardants are widely used in the art.

In the case of using additive-type flame retardants, mechanisms, such as stabilization of radicals generated upon combustion, and oxygen blocking, are used to secure flame retardancy. However, in order to impart flame retardancy to materials using such additive-type flame retardants, large amounts of flame retardants are used, causing disadvantages such as property change of a base material and deterioration in transparency. Therefore, additive-type flame retardants are not suitable for products requiring high transmittance.

In the case of using coating-type flame retardants, there is an advantage that properties of polymeric materials are retained. Therefore, flame retardant transparent films can be manufactured using a coating agent exhibiting transparency and flame retardancy. The present invention proposes a coating method, which imparts flame retardancy to a material without degradation of transparency using a transparent coating material.

### DISCLOSURE

### Technical Problem

It is an aspect of the present invention to provide a method for manufacturing a flame retardant transparent film by coating a base material with a flame retardant transparent material.

It is another aspect of the present invention to provide a flame retardant transparent film, which is manufactured by the method and exhibits outstanding flame retardancy without degradation of transparency.

### Technical Solution

In accordance with one aspect of the present invention, a method for manufacturing a flame retardant transparent film includes: (a) preparing a transparent base film; (b) forming a flame retardant coating layer by coating at least one surface of the base film with a flame retardant material including a polysilazane; (c) drying the flame retardant coating layer to remove remaining solvent from the coating layer; and (d) curing the flame retardant coating layer in a water vapor atmosphere, wherein a stacked body including the flame retardant coating layer and the base film has a haze value of 0.3 or less.

In accordance with another aspect of the invention, a flame retardant transparent film includes: a base film; and a flame retardant coating layer formed on at least one surface of the base film, wherein the flame retardant transparent film has a haze value of 0.3 or less and the flame retardant coating layer includes a polysilazane.

### Advantageous Effects

In a method for manufacturing a flame retardant transparent film according to embodiments, since flame retardancy is obtained by coating at least one surface of a base film with a flame retardant transparent material, the flame retardant transparent film may exhibit optimal transparency.

According to embodiments of the invention, a flame retardant transparent film includes a flame retardant coating layer including a polysilazane and has a haze value of 0.3 or less while securing outstanding flame retardancy.

### DESCRIPTION OF DRAWINGS

FIG. 1 is a schematic flowchart of a method for manufacturing a flame retardant transparent film according to one embodiment of the present invention.

FIG. 2 is a sectional view of a flame retardant transparent film according to one embodiment of the present invention.

### BEST MODE

The above and other aspects, features, and advantages of the present invention will become apparent from the detailed description of the following embodiments in conjunction with the accompanying drawings. It should be understood that the present invention is not limited to the following embodiments and may be embodied in different ways, and that the embodiments are provided for complete disclosure and a thorough understanding of the invention by those skilled in the art. The scope of the present invention is defined only by the claims. Like components will be denoted by like reference numerals throughout the specification.

Now, embodiments of the invention will be described in detail with reference to the accompanying drawings.

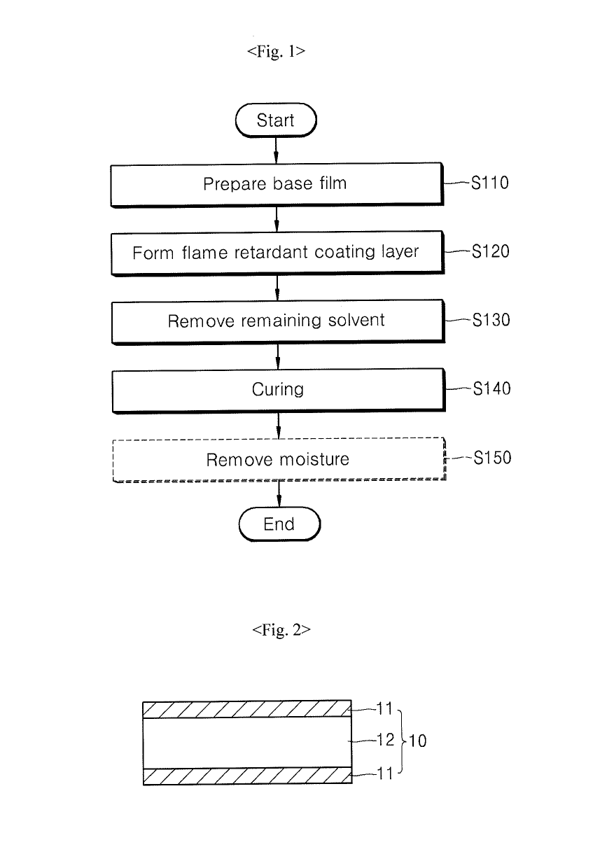

FIG. 1 is a schematic flowchart of a method for manufacturing a flame retardant transparent film according to one embodiment of the present invention.

Referring to FIG. 1, a method for manufacturing a flame retardant transparent film includes: preparing a transparent base film (S 110); forming a flame retardant coating layer (S 120); removing a remaining solvent from the flame retardant coating layer (S 130); and curing the flame retardant coating layer (S 140).

In one embodiment, the method for manufacturing a flame retardant transparent film may further include removing remaining moisture from the flame retardant coating layer through heat treatment (S150).

First, to manufacture a flame retardant transparent film, a transparent base film is prepared in operation S110. Although any materials exhibiting transparency may be used as the base film without limitation, a resin composition including at least one type selected from the group consisting of acrylic resins, polycarbonate resins, acrylonitrile-butadiene-styrene resin, polyurethane resins, olefin resins, epoxy resins, melamine resins, and unsaturated polyester resins is preferred.

A base film prepared from such polymeric resins is superior to a base film prepared from other polymeric resins in terms of transparency, heat resistance, mechanical properties, and the like.

Next, in operation S120 of forming a flame retardant coating layer, the flame retardant coating layer is formed by coating at least one surface of the base film with a flame retardant material including a polysilazane

The flame retardant material is required to exhibit transparency and flame retardancy. The flame retardant coating layer according to embodiments of the invention is formed using a coating solution including a polysilazane, which exhibits excellent transparency and flame retardancy.

The polysilazane is a polymer having repeated Si—N (silicon-nitrogen) bonds in the molecule, and any polymer allowing easy conversion into silica can be used without limitation. Generally, a Si—N (silicon-nitrogen) bond includes a silicon atom bonded with two hydrogen atoms, allowing easy conversion into silica.

Polysilazanes may have molecular structures such as a straight chain structure, a branched straight chain structure, a branch structure, a ring structure, a cross-linking structure, or a combination thereof. These polysilazanes may be used alone or in combination thereof. As representative examples of these polysilazanes, there are polymers including repeated silazane units represented by Formula 1. It should be noted that the polymers include an oligomer.

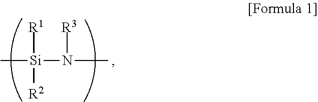

wherein R¹, R², and R³ are a hydrogen atom or a C₁-C₈ alkyl group, such as a methyl group, an ethyl group, a propyl group, and a butyl group.

To facilitate conversion into silica, the polysilazane preferably includes repeated units in which both R¹ and R² are hydrogen atoms, and more preferably, repeated units in which all of R¹, R² and R³ are hydrogen atoms.

When all of R¹, R² and R³ are hydrogen atoms, the polysilazane has repeated units represented by Formula 2, and is called perhydropolysilazane.

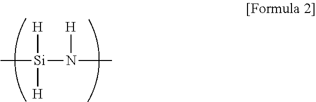

Perhydropolysilazane includes chemical structure moieties represented by Formula 3:

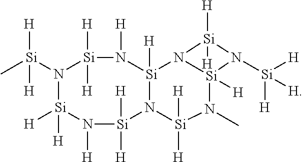

Some of the hydrogen atoms bonded to silicon atoms in the perhydropolysilazane may be substituted by hydroxyl groups.

After obtaining adducts through reaction between dihydrogendichlorosilane and an organic base (for example, pyridine or picoline), the perhydropolysilazane may be easily obtained by reacting the adducts with ammonia.

The polysilazane, particularly, perhydropolysilazane generally has a number-average molecular weight of 100 to 50,000, and preferably 200 to 2,500 in consideration of volatility upon heating and solubility in solvents.

The polysilazane, particularly, perhydropolysilazane, which is included in the flame retardant material of the flame retardant transparent film according to the embodiment, may include a small amount of a silica conversion accelerating catalyst.

Examples of the silica conversion accelerating catalyst may include organic amine compounds, organic acids, inorganic acids, carboxylic acid metal salts, and organo-metallic complex salts.

Particularly, organic amine compounds are preferred, and examples of organic amine compounds may include nitrogen-containing cyclic organic amines, such as 1-methylpiperazine, 1-methylpiperizine, 4,4′-trimethylenedipiperizine, 4,4′-trimethylenebis(1-methylpiperizine), diazabicyclo-[2,2,2]octane, cis-2,6-dimethylpiperazine, 4-(4-methylperizine)pyridine, pyrizine, dipyridine, α-picoline, β-picoline, γ-picoline, piperizine, lutidine, pyrimidine, pyridazine, 4,4′-trimethylenedipyridine, 2-(methylamino)pyrizine, pyrazine, quinoline, quinoxaline, triazine, pyrrole, 3-pyrroline, imidazole, triazole, tetrazole, 1-methylpyrrolidine, and the like; aliphatic or aromatic amines, such as methylamine, dimethylamine, trimethylamine, ethyamine, diethylamine, triethylamine, propylamine, dipropylamine, tripropylamine, butylamine, dibutylamine, tributylamine, pentylamine, dipentylamine, tripentylamine, hexylamine, dihexylamine, trihexylamine, heptylamine, diheptylamine, octylamine, dioctylamine, trioctylamine, phenylamine, diphenylamine, triphenylamine, and the like; DBU(1,8-diazabicyclo[5,4,0]7-undecene), DBN (1,5-diazabicyclo[4,3,0]5-nonene), 1,5,9-triazacyclododecane, and 1,4,7-triazacyclononane.

The silica conversion accelerating catalyst may be present in an amount of 0.1% by weight (wt %) to 10 wt % based on the total weight of the polysilazine, particularly, perhydropolysilazane.

By coating surfaces of the flame retardant transparent film according to the embodiment with a polysilazane solution, a layer exhibiting excellent transparency and outstanding flame retardancy can be formed on the surfaces of the flame retardant transparent film.

Next, in operation S130 of removing remaining solvent, the remaining solvent is removed from the flame retardant coating layer by drying the flame retardant coating layer.

Operation S130 of removing the remaining solvent is performed to preliminarily cure the flame retardant coating layer while improving densification of the flame retardant coating layer after curing. Here, although not limited to a specific method, the removal of the remaining solvent is performed using a hot-air dryer at 40° C. to 100° C.

If the removal of the remaining solvent is performed below 40° C., the remaining solvent can be insufficiently removed. If the removal of the remaining solvent is performed above 100° C., bubbles can be generated and the coating layer can be delaminated from the base layer.

Next, operation S140 of curing the flame retardant coating layer is performed in a water vapor atmosphere. Water vapor is important for the polysilazane compound to be sufficiently converted into a silicon dioxide layer. The water vapor atmosphere may have a water vapor concentration of 70% or more. If the water vapor concentration is less than 70%, it is difficult for an organic compound to be converted into a silica-based layer, causing creation of defects such as voids and the like. In operation S140 of curing the flame retardant coating layer, an inert gas atmosphere such as nitrogen, argon, helium, and the like, may be used.

The flame retardant transparent film may be manufactured through a series of operations as described above.

The method for manufacturing a flame retardant transparent film according to the embodiment may further include removing residual moisture from the flame retardant coating layer by heat treatment (S 150). Since the residual moisture in the flame retardant coating layer can cause oxidation, denaturation, and the like, advantageously, the method may further include removing the residual moisture from the flame retardant coating layer.

Heat treatment may be performed using an apparatus such as a hot-air dryer to remove residual moisture from the flame retardant coating layer.

FIG. 2 is a sectional view of a flame retardant transparent film 10 according to one embodiment of the invention.

Referring to FIG. 2, a flame retardant transparent film 10 according to one embodiment includes a base film 12, and a flame retardant coating layer 11 foamed on at least one surface of the base film 12, wherein the flame retardant coating layer 11 includes a polysilazane and has a haze value of 0.3 or less.

Although any material exhibiting transparency can be used as the base film without limitation, a resin composition including at least one selected from the group consisting of acrylic resins, polycarbonate resins, acrylonitrile-butadiene-styrene resins, polyurethane resins, olefin resins, epoxy resins, melamine resins, and unsaturated polyester resins is preferred.

The base film 12 prepared from such polymeric resins is superior to a base film prepared from other polymeric resins in terms of transparency, heat resistance, mechanical properties, and the like.

In particular, for the flame retardant transparent film 10 requiring both flame retardancy and transparency, a resin composition including polymethyl methacrylate (PMMA), diglycolcarbonate, or a cycloolefin copolymer (COC) as a main component may be used.

Conventionally, high transmittance products requiring transparency have difficulty in securing outstanding flame retardancy. However, in the flame retardant transparent film 10 according to the embodiments of the invention, the flame retardant coating layer 11 formed of the flame retardant material including a polysilazane is coated onto the base film 12, thereby providing transparency while securing outstanding flame retardancy.

In addition, the flame retardant transparent film 10 according to the embodiments has a haze value of 0.3 or less and a light transmittance of 90% or more as measured according to ASTM D1003. When the flame retardant transparent film has a haze value of more than 0.3, the flame retardant transparent film 10 suffers limited application to transparent films.

### EXAMPLES

### Example 1

Using polymethyl methacrylate (PMMA) as a main component, a 2 mm thick base film specimen was prepared through injection molding. Next, the specimen was immersed in a bath filled with a coating solution containing 5 wt % of perhydropolysilazane in a xylene solvent to foam a flame retardant coating layer on surfaces of the base film. With the surfaces of the specimen sufficiently wetted with the solution, the specimen was removed from the solution and left in a convection oven at 60° C. for 10 minutes to evaporate the remaining solvent from the specimen. Next, after placing the specimen in a thermo-hygrostat and curing the same at a temperature of 60° C. and 90% RH for 24 hours, a flame retardant transparent film including a flame retardant coating layer was prepared.

### Example 2

A flame retardant transparent film was prepared in the same manner as in Example 1 except that a polymer resin including polyethylene terephthalate glycol (PETG) was used as a main component and a base film specimen was prepared through injection molding.

### Example 3

A flame retardant transparent film was prepared in the same manner as in Example 1 except that a polymer resin including polycarbonate (PC) was used as a main component and a base film specimen was prepared through injection molding.

### Example 4

A flame retardant transparent film was prepared in the same manner as in Example 1 except that a polymer resin including a cyclo-olefin copolymer (COC) was used as a main component and a base film specimen was prepared through injection molding.

### Example 5

A flame retardant transparent film was prepared in the same manner as in Example 1 except that, instead of the perhydropolysilazane used in Example 1, a base film specimen was prepared using a polysilazane in which R¹ and R² are hydrogen atoms and R³ is a methyl group as the alkyl group.

### Example 6

A flame retardant transparent film was prepared in the same manner as in Example 1 except that, instead of the perhydropolysilazane used in Example 1, a base film specimen was prepared using a polysilazane in which R¹ and R² are hydrogen atoms and R³ is an ethyl group as the alkyl group.

### Example 7

A flame retardant transparent film was prepared in the same manner as in Example 1 except that, instead of the perhydropolysilazane used in Example 1, a base film specimen was prepared using a polysilazane in which R¹ and R² are hydrogen atoms and R³ is a nonyl group as the alkyl group.

### Comparative Example 1

A flame retardant transparent film was prepared in the same manner as in Example 1 except that a flame retardant coating layer was not formed.

### Comparative Example 2

A flame retardant transparent film was prepared in the same manner as in Example 2 except that a flame retardant coating layer was not formed.

### Comparative Example 3

A flame retardant transparent film was prepared in the same manner as in Example 3 except that a flame retardant coating layer was not formed.

### Comparative Example 4

A flame retardant transparent film was prepared in the same manner as in Example 4 except that a flame retardant coating layer was not fouled.

### Experimental Example

Specimens of the flame retardant films in the inventive examples and the comparative examples were prepared.

1) Flame retardancy of the specimens was evaluated, and results are shown in Table 1. Flame retardancy was evaluated according to a horizontal testing method. A flame having a length of 2 cm was applied to each of the specimens in a horizontal direction. Here, a flame having a blue color without a red color was used. In addition, the flame was continuously applied thereto.

2) Optical properties of the specimens prepared in the inventive examples and the comparative examples were evaluated. To evaluate light transmittance, haze values and light transmittances of the specimens were measured according to ASTM D1003.

TABLE 1

| | Combustion start time (sec) | | |
|---|---|---|---|
| | Soot gener- | Combustion | Complete |
| | ation time | start time | combustion time |
| Example 1 | 30 | 60 | 120 |
| Comparative Example 1 | 5 | 10 | 30 |
| Example 2 | 30 | 60 | 180 |
| Comparative Example 2 | 5 | 20 | 45 |
| Example 3 | 30 | 60 | 160 |
| Comparative Example 3 | 5 | 15 | 35 |
| Example 4 | 30 | 60 | 180 |
| Comparative Example 4 | 5 | 10 | 30 |
| Example 5 | 25 | 55 | 115 |
| Example 6 | 25 | 55 | 115 |
| Example 7 | 20 | 50 | 110 |

TABLE 2

| | Haze (%) | Light Transmittance (%) |
|---|---|---|
| Example 1 | 0.25 | 91 |
| Comparative Example 1 | 0.15 | 92 |
| Example 2 | 0.23 | 91 |
| Comparative Example 2 | 0.16 | 92 |
| Example 3 | 0.2 | 91 |
| Comparative Example 3 | 0.08 | 92 |
| Example 4 | 0.28 | 91 |
| Comparative Example 4 | 0.17 | 92 |
| Example 5 | 0.27 | 92 |
| Example 6 | 0.29 | 92 |
| Example 7 | 0.29 | 92 |

Referring to Table 1, for the specimens each having a flame retardant coating layer in the inventive examples, the soot generation time was about 30 seconds, and the specimens were completely combusted after 2 minutes to 3 minutes. On the contrary, in the specimens in the comparative examples having no flame retardant coating layer, the soot generation time was about 5 seconds and the specimens were completely combusted after 30 seconds to 40 seconds.

Therefore, it could be seen that the films having the flame retardant coating layers were superior to the films having no flame retardant coating layer in terms of flame retardancy.

In addition, it could be seen that the specimens each having a flame retardant coating layer including perhydropolysilazane in Examples 1 to 4 were superior to the specimens prepared in Examples 5 to 7 in terms of flame retardancy. That is, since perhydropolysilazane used in Examples 1 to 4 can be more easily converted into silica than polysilazane used in other examples, coating layers including perhydropolysilazane exhibited more outstanding flame retardancy than the other specimens. In addition, it could be seen that the specimens prepared using the polysilazane having hydrogen atoms and C₁-C₈ alkyl groups in Examples 5 and 6 were superior to the specimen prepared using the polysilazane having hydrogen atoms and a C₉ nonyl group in Example 7 in terms of flame retardancy.

Referring to Table 2, the specimens having a flame retardant coating layer in the inventive examples also exhibited an excellent transmittance of 90% or more as in the specimens having no flame retardant coating layer. Further, the specimens of the inventive examples had a haze value of 0.3 or less.

That is, since the specimens of Examples 3 and 4 were formed with the flame retardant coating layer using a coating solution containing a polysilazane exhibiting excellent transparency as a main component, these specimens could exhibit excellent transparency in spite of flame retardant treatment.

That is, the flame retardant transparent film according to the present invention may exhibit substantially the same transparency as general transparent films which are not subjected to flame retardancy treatment.

Although some embodiments have been described herein, it will be understood by those skilled in the art that these embodiments are provided for illustration only, and that various modifications, changes, alterations and equivalent embodiments can be made without departing from the scope of the invention. Therefore, the scope and spirit of the invention should be defined only by the accompanying claims and equivalents thereof.

1. A method for manufacturing a flame retardant transparent film comprising:
(a) preparing a transparent base film;
(b) forming a flame retardant coating layer by coating at least one surface of the base film with a flame retardant material comprising a polysilazane;
(c) drying the flame retardant coating layer to remove remaining solvent from the coating layer; and
(d) curing the flame retardant coating layer in a water vapor atmosphere,
wherein a stacked body comprising the flame retardant coating layer and the base film has a haze value of 0.3 or less.

2. The method according to claim 1, wherein the polysilazane comprises repeated units represented by Formula 1: 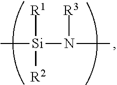
wherein R¹, R² and R³ are a hydrogen atom or a C₁-C₈ alkyl group, such as a methyl group, an ethyl group, a propyl group, and a butyl group.

3. The method according to claim 1, wherein the polysilazane is perhydropolysilazane.

4. The method according to claim 1, wherein the polysilazane comprises a catalytic amount of a silica conversion accelerating catalyst, and the silica conversion accelerating catalyst comprises an amine catalyst.

5. The method according to claim 1, wherein the base film comprises at least one selected from the group consisting of acrylic resins, polycarbonate resins, acrylonitrile-butadiene-styrene resins, polyurethane resins, olefin resins, epoxy resins, melamine resins, and unsaturated polyester resins.

6. The method according to claim 1, further comprising: (e) removing residual moisture from the flame retardant coating layer through heat treatment.

7. The method according to claim 1, wherein the (c) drying the flame retardant coating layer is performed at a temperature of 40° C. to 100° C.

8. The method according to claim 1, wherein the (d) curing the flame retardant coating layer is performed at a temperature of 40° C. to 100° C. and a relative humidity of 70% or more.

9. A flame retardant transparent film comprising:
a base film; and
a flame retardant coating layer formed on at least one surface of the base film,
wherein the flame retardant transparent film has a haze value of 0.3 or less, and the flame retardant coating layer comprises a polysilazane.

10. The flame retardant transparent film according to claim 9, wherein the polysilazane comprises repeated units represented by Formula 1: 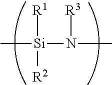
wherein R¹, R², and R³ are a hydrogen atom or a C₁-C₈ alkyl group, such as a methyl group, an ethyl group, a propyl group, and a butyl group.

11. The flame retardant transparent film according to claim 9, wherein the polysilazane is perhydropolysilazane.

12. The flame retardant transparent film according to claim 9, wherein the polysilazane comprises a catalytic amount of a silica conversion accelerating catalyst, and the silica conversion accelerating catalyst comprises an amine-based catalyst.

13. The flame retardant transparent film according to claim 9, wherein the base film comprises at least one selected from the group consisting of acrylic resins, polycarbonate resins, acrylonitrile-butadiene-styrene resins, polyurethane resins, olefin resins, epoxy resins, melamine resins, and unsaturated polyester resins.
